(19) United States
(12) Patent Application Publication
(10) Pub. No.: US 2026/0171955 A1
(43) Pub. Date: Jun. 18, 2026

(54) SAFETY WALKWAY WITH A POWER GENERATING DEVICE

(71) Applicant: Sunny Rich Agric. & Biotech Co., Ltd., Taipei City (TW)

(72) Inventor: Kuei-Kuang Chen, Taipei City (TW)

(21) Appl. No.: 19/310,103

(22) Filed: Aug. 26, 2025

(30) Foreign Application Priority Data
Dec. 17, 2024 (TW) 113149213

(51) Int. Cl. H02S 20/23; E04G 3/00; H02S 20/30

(52) U.S. Cl. CPC H02S 20/23; E04G 3/00; H02S 20/30

(57) ABSTRACT

A safety walkway with a power generating device is securely mounted to a light-receiving suspended location on a building and comprises a base plate, a plurality of solar panels, and a control device. The base plate includes an inner side and an outer side. The inner side is configured to be securely connected to the building, such that the base plate is substantially parallel to the ground. The plurality of solar panels is pivotably mounted to the outer side of the base plate. Each of the plurality of solar panels includes at least one light receiving face. The control device is coupled to the plurality of solar panels and is configured to control the plurality of solar panels to be perpendicular or at a non-perpendicular angle to the base plate.

### BACKGROUND OF THE INVENTION

The present invention relates to a safety walkway with a power generating device and, more particularly, to a power generating device capable of increasing the power generation efficiency of a safety walkway.

Currently, greenhouses or other sequentially connected buildings generally include stairways, permitting persons to climb the stairways to a height for maintaining or cleaning the rooftop. In terms of a greenhouse, the greenhouse includes a plurality of vertical columns below the rooftop, and plural greenhouses may be connected to form a large-area planting field.

In order to maintain and clean the rooftop, now it is possible to dispose a stairway at a column of each greenhouse, so that persons may climb to the rooftop by the stairway. However, when it is desired to maintain the rooftop of another greenhouse, the persons have to climb down the stairway and go to another stairway to be climbed, causing inconvenience for maintenance and cleaning. Furthermore, an area of the rooftop between two stairways is difficult to maintain and clean.

### BRIEF SUMMARY OF THE INVENTION

An objective of the present invention is to provide a suspended safety walkway which may be disposed on a greenhouse or other buildings, and the safety walkway may provide enhanced walking safety and enhanced solar power generation efficiency.

A safety walkway with a power generating device according to the present invention is configured to be securely mounted to a light-receiving suspended location on a building. The safety walkway comprises a base plate, a plurality of solar panels, and a control device. The base plate includes an inner side and an outer side. The inner side is configured to be securely connected to the building, such that the base plate is substantially parallel to the ground. The plurality of solar panels is pivotably mounted to the outer side of the base plate. Each of the plurality of solar panels includes at least one light receiving face. The control device is coupled to the plurality of solar panels and is configured to control the plurality of solar panels to be perpendicular or at a non-perpendicular angle to the base plate.

In an example, the base plate includes a top surface provided with reflective material.

In an example, each of the plurality of solar panels includes a first light receiving face and a second light receiving face. Each of the first and second light receiving faces is configured to receive light to generate electricity.

In an example, each of the plurality of solar panels includes a first pivotal portion at a substantially middle position thereof and a second pivotal portion at a lower side thereof. The first pivotal portion is pivotably connected to the outer side of the base plate. The control device includes at least one telescopic rod and a controller. The at least one telescopic rod is electrically connected to the controller and includes a first end and a second end. The first end of the at least one telescopic rod is pivotably connected to the second pivotal portions of the plurality of solar panels. The second end of the at least one telescopic rod is pivotably connected to the building or the base plate. The controller is configured to control a length of the telescopic rod and an angle between the plurality of solar panels and the base plate.

According to the present invention, when persons need to walk on the safety walkway, the solar panels are adjusted to be perpendicular to the base plate through control by the control device. The solar panels do not occupy the space above the base panel, allowing the persons to walk easily on the top surface. Furthermore, the upper part of the solar panels may serve as a railing on the outer side of the safety walkway, providing safety protection at the outer side of the safety walkway.

During the daytime, the controller of the control device according to the present invention may be used to control movement of the telescopic rod, moving the first light receiving face to a position corresponding to the incident angle of the sunlight to thereby increase the power generation efficiency. Furthermore, the second light receiving face may receive the light rays reflected by the top surface of the base plate and the building to further increase the power generation efficiency of the solar panels.

The present invention will become clearer in light of the following detailed description of illustrative embodiments of this invention described in connection with the drawings.

### DESCRIPTION OF THE DRAWINGS

FIG. 1 is a schematic perspective view illustrating installation of a safety walkway with a power generating device according to the present invention.

FIG. 2 is a schematic side view of the safety walkway with a power generating device according to the present invention, with solar panels in a vertical position.

FIG. 3 is a schematic front view of the safety walkway with a power generating device according to the present invention.

FIG. 4 is a schematic side view of the safety walkway with a power generating device according to the present invention, with the solar panels in an inclined state.

### DETAILED DESCRIPTION OF THE INVENTION

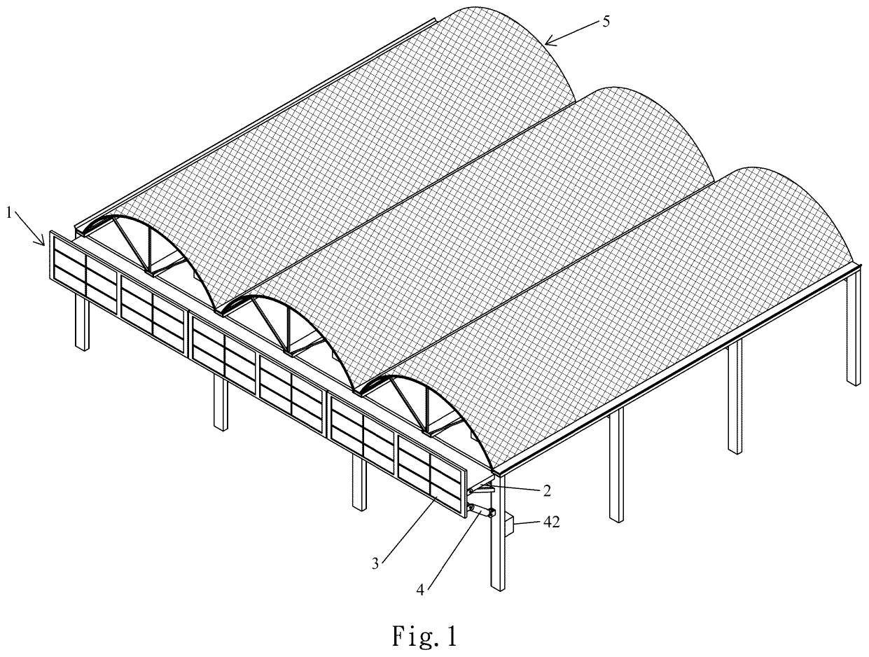

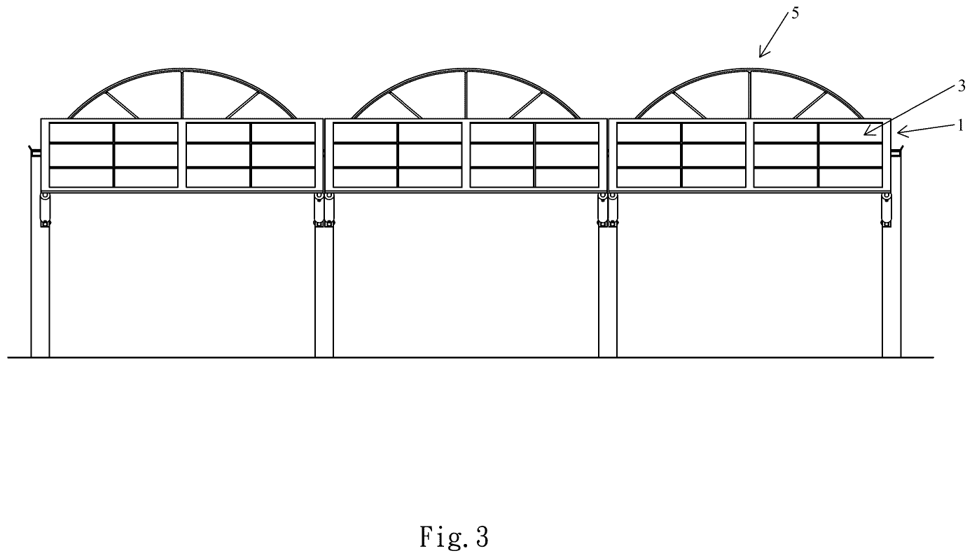

With reference to FIGS. 1-3, a safety walkway 1 with a power generating device according to the present invention is configured to be securely mounted to a light-receiving suspended location on a building 5. The building 5 may be a greenhouse, a townhouse, or any other outdoor building. In this embodiment, the building 5 may be a greenhouse, and the safety walkway 1 is mounted outside of a body of the greenhouse, such that the safety walkway 1 will not affect the light transmittance of the body of the greenhouse and the growth of plants in the greenhouse. Furthermore, the safety walkway 1 in this embodiment may include only one stairway (not shown) mounted to the body of the greenhouse. Namely, plural stairways are not necessary. The safety walkway 1 according to the present invention 1 comprises a base plate 2, a plurality of solar panels 3, and a control device 4. The base plate 2 includes an inner side 21, an outer side 22, and a top surface 23. The inner side 21 is configured to be securely connected to the building 5, such that the top surface 23 and the base plate 2 are substantially parallel to the ground. Furthermore, the top surface 23 is provided with a reflective layer, is electroplated, or includes any reflective material.

The plurality of solar panels 3 is pivotably mounted to the outer side 22 of the base plate 2. Each of the plurality of solar panels 3 includes a first pivotal portion 33 at a substantially middle position thereof and a second pivotal portion 34 at a lower side thereof. The first pivotal portion 33 is pivotably connected to the outer side 22 of the base plate 2.

The control device 4 is coupled to the plurality of solar panels 3 and is configured to control the plurality of solar panels 3 to be perpendicular or at a non-perpendicular angle to the base plate 2. The control device 4 includes at least one telescopic rod 41 and a controller 42. The at least one telescopic rod 41 may be a hydraulic rod or a pneumatic rod and may be electrically connected to the controller 41 via an electric motor. The at least one telescopic rod 41 includes a first end 411 and a second end 412. The first end 411 of the at least one telescopic rod 41 is pivotably connected to the second pivotal portions 34 of the plurality of solar panels 3. The second end 412 of the at least one telescopic rod 41 is pivotably connected to the building 5. The controller 4 is configured to control a length of the telescopic rod 41 and an angle between the plurality of solar panels 3 and the base plate 2.

According to the present invention, when persons need to walk on the safety walkway 1, the solar panels 3 are adjusted to be perpendicular to the base plate 2 through control by the control device 4. The solar panels 3 do not occupy the space above the base panel 2, allowing the persons to walk easily on the top surface 23. Furthermore, the upper part of the solar panels 3 may serve as a railing on the outer side of the safety walkway 1, providing safety protection at the outer side of the safety walkway 1.

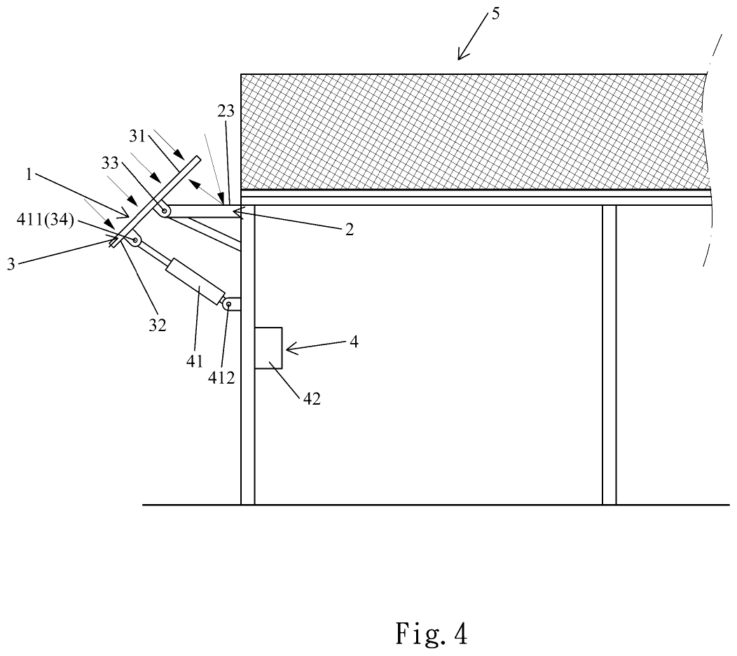

Referring to FIG. 4, during the daytime, the controller 42 of the control device 4 according to the present invention may be used to control movement of the telescopic rod 41, moving the first light receiving face 31 to a position corresponding to the incident angle of the sunlight to thereby increase the power generation efficiency. Furthermore, the second light receiving face 32 may receive the light rays reflected by the top surface 23 of the base plate 2 and the building 5 to further increase the power generation efficiency of the solar panels 3.

During a typhoon, the controller 42 according to the present invention may be used to control movement of the telescopic rod 41, such that the solar panels 3 may be moved to a position at an inclination angle with respect to the base panel 2 to thereby achieve a wind breaking effect while increasing the wind resistance of the safety walkway 1.

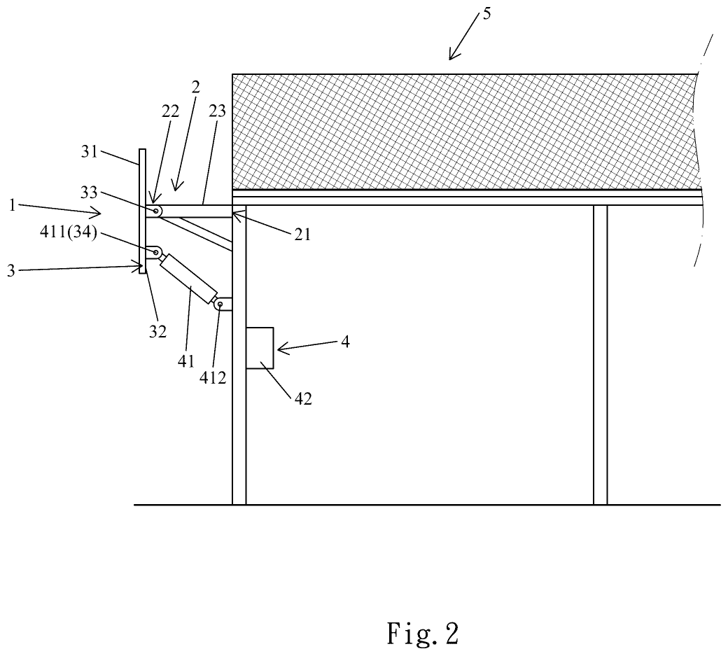

During the nighttime, the controller 42 according to the present invention may be used to control movement of the telescopic rod 41 to return the solar panel 3 to the position perpendicular to the base panel 2, as shown in FIG. 2. This may reduce filthy on the first light receiving face 31 caused by dusts or bird excrements, improving the surface cleaning efficiency and the power generation efficiency of the solar plates 3.

In view of the foregoing, the present invention provides a safety walkway 1 with enhanced safety, enhanced power generation efficiency, and enhanced wind breaking effect through provision of the solar panels 3 serving as a railing. The foregoing embodiments are examples of the present invention, not limitation to the present invention. All equivalent changes made in accordance with the spirit of the present invention should also fall within the scope of the present invention.

1. A safety walkway with a power generating device, with safety walkway configured to be securely mounted to a light-receiving suspended location on a building, with the safety walkway comprising:
a base plate including an inner side and an outer side, wherein the inner side is configured to be securely connected to the building, such that the base plate is substantially parallel to a ground;
a plurality of solar panels pivotably mounted to the outer side of the base plate, wherein each of the plurality of solar panels includes at least one light receiving face; and
a control device coupled to the plurality of solar panels and configured to control the plurality of solar panels to be perpendicular or at a non-perpendicular angle to the base plate.

2. The safety walkway with the power generating device as claimed in claim 1, wherein the base plate includes a top surface provided with reflective material.

3. The safety walkway with the power generating device as claimed in claim 2, wherein the at least one light receiving face of each of the plurality of solar panels includes a first light receiving face and a second light receiving face, and wherein each of the first and second light receiving faces is configured to receive light to generate electricity.

4. The safety walkway with the power generating device as claimed in claim 1, wherein each of the plurality of solar panels includes a first pivotal portion at a substantially middle position thereof and a second pivotal portion at a lower side thereof, wherein the first pivotal portion is pivotably connected to the outer side of the base plate, wherein the control device includes at least one telescopic rod and a controller, wherein the at least one telescopic rod is electrically connected to the controller and includes a first end and a second end, wherein the first end of the at least one telescopic rod is pivotably connected to the second pivotal portions of the plurality of solar panels, wherein the second end of the at least one telescopic rod is pivotably connected to the building or the base plate, and wherein the controller is configured to control a length of the telescopic rod and an angle between the plurality of solar panels and the base plate.

5. The safety walkway with the power generating device as claimed in claim 1, wherein the building is a greenhouse.

6. The safety walkway with the power generating device as claimed in claim 5, wherein the safety walkway is mounted outside of a body of the greenhouse.

7. The safety walkway with the power generating device as claimed in claim 1, wherein the building is a townhouse.
